(19) United States
(12) Patent Application Publication
(10) Pub. No.: US 2012/0209941 A1
(43) Pub. Date: Aug. 16, 2012

(54) COMMUNICATION APPARATUS, AND APPARATUS AND METHOD FOR CONTROLLING COLLECTION OF STATISTICAL DATA

(75) Inventor: Kanta YAMAMOTO, Kawasaki (JP)

(73) Assignee: FUJITSU LIMITED, Kawasaki-shi (JP)

(21) Appl. No.: 13/457,166

(22) Filed: Apr. 26, 2012

Related U.S. Application Data
(63) Continuation of application No. PCT/JP2009/070810, filed on Dec. 14, 2009.

(51) Int. Cl. G06F 15/167

(52) U.S. Cl. 709/212

(57) ABSTRACT

In a communication apparatus, a collector collects a plurality of statistical data values describing communication activities, based on given user data frames, and produces statistics transmission data including the collected statistical data values and management data tags added thereto. A controller transfers, by using a direct memory access technique, the statistics transmission data produced by the collector. A memory stores the statistics transmission data transferred by the controller.

### CROSS-REFERENCE TO RELATED APPLICATION

This application is a continuing application, filed under 35 U.S.C. §111(a), of International Application PCT/JP2009/070810, filed on Dec. 14, 2009.

### FIELD

The embodiments discussed herein relate to a communication apparatus that collects statistical data of communication activities, as well as to an apparatus and a method for controlling collection of such statistical data.

### BACKGROUND

Switches and other communication devices are used to transfer data in packets or similar form. Those communication devices have a forwarding processor to execute termination of various protocol packets. Some forwarding processors offer the functionality of operations, administration and maintenance (OAM) for individual services, known as Link OAM and Service OAM. Generally, a communication device with OAM functions collects statistical data about its communication activities by using a software-based method. Direct memory access (DMA) techniques may also be introduced for the purpose of enhancement of data processing speeds. DMA makes it possible to transfer data under hardware control, while arbitrating write operations to memory devices which may be accessed by software applications. See, for example, Japanese Laid-open Patent Publication No. 60-100251.

The software processing in the above-noted communication device is heavily loaded all the time, because a large amount of data has to be handled during the process of statistical data collection. Interface cards in the communication device, on the other hand, confront a problem of performance saturation with their internal control bus (e.g., peripheral component Interconnect (PCI) bus) for the central processing unit (CPU). Further, recent years have seen a growing demand for communication devices that provide more communication ports and more service flows in their interface cards. This also means an increase in the amount of statistical data values. That is, the communication device is supposed to collect in a short time the entire set of information about packet statistics that may change at regular intervals, for use in the management information base (MIB), for example. As a result, the statistical data collection process would constantly occupy the CPU control bus at a high ratio.

To meet the requirements discussed above, an increased load is imposed on the communication devices with OAM functions. The resulting shortage of performance margin makes it difficult to implement new features or applications for data communication and statistical data collection. The development of techniques for reducing software processing has therefore been a pressing need.

Relaxing the requirement of update intervals of statistical data may be an option in the case where the CPU control bus is nearing its performance saturation as Mentioned above. Even if this is possible, it is still difficult to increase the number of data bits of each statistical record, considering the fact that the statistical data memory as part of communication device hardware has to retain a large amount of collected data during the collection interval. While it may only be a few bits per record, an increase in the size of each record of statistical data would consume a non-negligible amount of extra storage space in the statistical data memory as a whole because the memory accommodates thousands of such records.

### SUMMARY

According to an aspect of the embodiments, there is provided a communication apparatus including collector that collects a plurality of statistical data values describing communication activities, based on given user data frames, and produces statistics transmission data including the collected statistical data values and management data tags added thereto; a controller that transfers, by using a direct memory access technique, the statistics transmission data produced by the collector; and a memory that stores the statistics transmission data transferred by the controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a first embodiment;

FIG. 2 is an overall block diagram of a communications system according to a second embodiment;

FIG. 3 illustrates a hardware configuration of a switch according to the second embodiment;

FIG. 4 illustrates a structure of an interface card according to the second embodiment;

FIG. 5 is a functional block diagram of the interface card according to the second embodiment;

FIG. 6 illustrates a group of counters used for received frames according to the second embodiment;

FIG. 7 illustrates another group of counters used for received frames according to the second embodiment;

FIG. 8 illustrates a group of counters used for outgoing frames according to the second embodiment;

FIG. 9 illustrates another group of counters used for outgoing frames according to the second embodiment;

FIG. 10 illustrates operation of the counters according to the second embodiment;

FIGS. 11 and 12 are a flowchart illustrating a process of generating statistics transmission data according to the second embodiment;

FIG. 13 illustrates an exemplary data structure of statistics transmission data frames according to the second embodiment;

FIG. 14 illustrates another example data structure of statistics transmission data frames according to the second embodiment;

FIGS. 15A and 15B illustrate an exemplary data structure of a statistics transmission data frame according to the second embodiment, and how a normal frame Rx counter changes its value;

FIGS. 16A and 16B illustrate another exemplary data structure of a statistics transmission data frame according to the second embodiment, and how a unicast frame Rx counter changes its value;

FIGS. 17A and 17B illustrate yet another exemplary data structure of a statistics transmission data frame according to the second embodiment, and how an Rx byte counter changes its value;

FIGS. 18A and 18B illustrate yet another exemplary data structure of a statistics transmission data frame according to the second embodiment, and how a designated-size frame Rx counter changes its value;

FIGS. 19A and 19B illustrate still another exemplary data structure of a statistics transmission data frame according to the second embodiment, and how a flow-specific normal frame Rx counter changes its value;

FIGS. 20A and 20B illustrate still another exemplary data structure of a statistics transmission data frame according to the second embodiment, and how a flow-specific Rx byte counter changes its value;

FIGS. 21A and 21B illustrate exemplary data structures of duplicated frames according to the second embodiment; and

FIG. 22 is a functional block diagram of an interface card according to a third embodiment.

### DESCRIPTION OF EMBODIMENTS

Several embodiments will be described below with reference to the accompanying drawings, wherein like reference numerals refer to like elements throughout.

### (a) FIRST EMBODIMENT

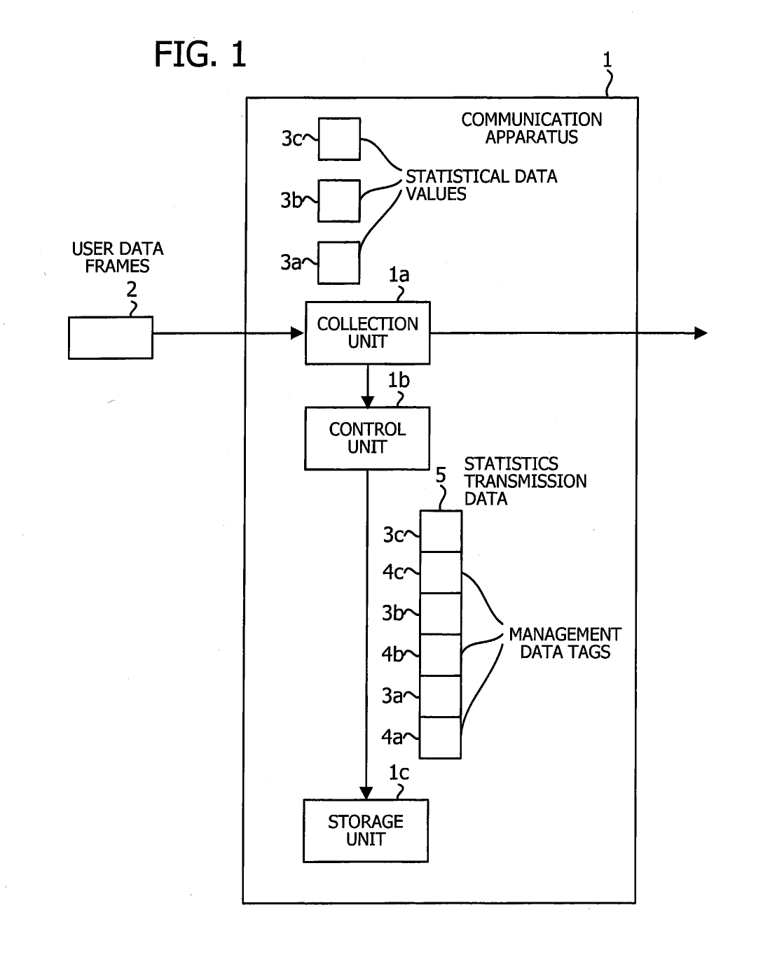

FIG. 1 illustrates a first embodiment. The illustrated communication apparatus 1 includes a collection unit 1a, a control unit 1b, and a storage unit 1c. The collection unit 1a collects a plurality of statistical data values (as denoted by reference numerals 3a, 3b, 3c) describing communication activities, based on user data frames 2 received by the communication apparatus 1. The collection unit 1a produces statistics transmission data 5 that includes the plurality of collected statistical data values 3a, 3b, and 3c and management data tags (as denoted by reference numerals 4a, 4b, 4c) added thereto. These features enable the communication apparatus 1 to collect a plurality of statistical data values 3a, 3b, and 3c from each received user data frame 2 and transfer the collected statistical data values 3a, 3b, and 3c all together, with a reduced workload. The management data tags 4a, 4b, and 4c in the statistics transmission data 5 may be used to manage statistical data values 3a, 3b, and 3c when, for example, they are transmitted. For example, processing which the collection unit 1a performs is performed by the processor.

The control unit 1b transfers the produced statistics transmission data 5 to a storage unit 1c by using a direct memory access technique. In other words, statistical data values 3a, 3b, and 3c constituting the statistics transmission data 5 are written into the storage unit 1c with hardware processing. For example, processing which the control unit 1b performs is performed by the processor. The storage unit 1c stores the statistics transmission data 5 transferred by the control unit 1b. For example, the storage unit 1c is a memory.

With the above-described features, the proposed communication apparatus 1 can collect statistical data with a less amount of software processing, a lower occupancy of its CPU control bus, and a smaller memory requirement for storage of statistical data.

### (b) SECOND EMBODIMENT

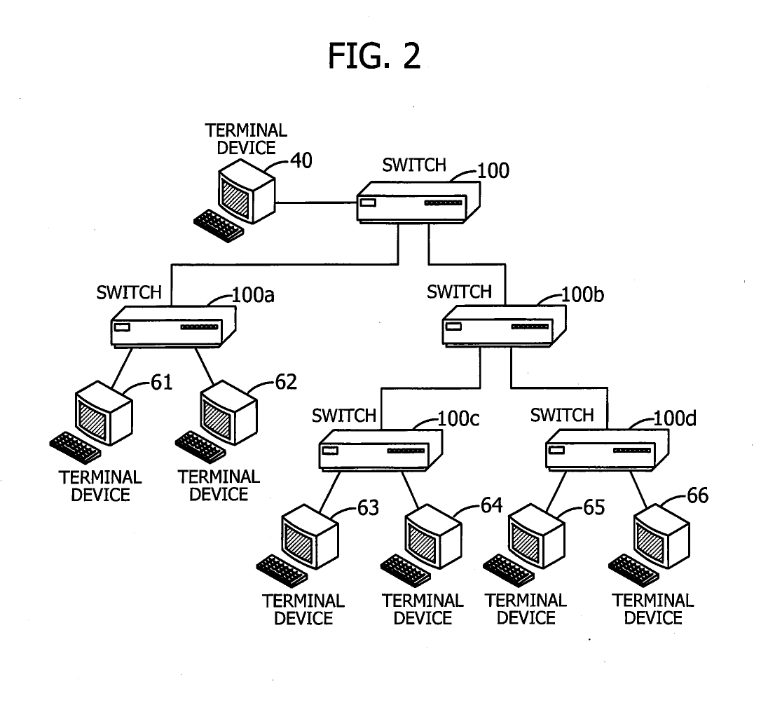

Referring to FIGS. 2 to 21, a second embodiment will now be described below. For illustrative purposes, this section will discuss a switch as an example of a communication apparatus, and more particularly, a layer-2 switch that relays frames of the data link layer according to specified media access control (MAC) addresses. It is noted, however, that the second embodiment is not limited to that specific type of switches or communication apparatuses. The second embodiment may also be applied to other devices such as Asynchronous Transfer Mode (ATM) switches, Frame Relay devices, and Internet Protocol (IP) routers and layer-3 switches for forwarding network-layer packets based on IP address. The term “frame” refers to layer-2 data units in the Open Systems Interconnection (OSI) reference model, while “packet” may be another term denoting the same. For the sake of expediency, the following description will use the former term, “frame,” in the noted sense.

FIG. 2 is an overall block diagram of a communications system according to the second embodiment. This communications system includes a plurality of layer-2 switches for routing packets of the data link layer so that data can be sent and received between a plurality of terminal devices.

Specifically the illustrated communications system of FIG. 2 is formed from a plurality of switches 100, 100a, 100b, 100c, and 100d and a plurality of terminal devices 40, 61, 62, 63, 64, 65, and 66. The switches 100, 100a, 100b, 100c, and 100d are layer-2 switches. One terminal device 40 is used by an administrator who manages the topmost switch 100 seen in FIG. 2, while the other terminal devices 61, 62, 63, 64, 65, and 66 are used by general users. Each switch 100a, 100b, 100c, and 100d has a similar structure to the switch 100 discussed in detail later and functions similarly to the switch 100.

The topmost switch 100 is linked to two switch 100a and 100b. The latter switch 100b is linked to another two switches 100c and 100d. Two terminal devices 61 and 62 are attached to the switch 100a. Another two terminal devices 63 and 64 are attached to the switch 100c. Yet another two terminal devices 65 and 66 are attached to the switch 100d. As mentioned above, one terminal device 40 is attached to the switch 100. One or more physical links (network cables) are routed to make switch-to-switch connections and switch-to-terminal connections.

The switches 100, 100a, 100b, 100c, and 100d relays transmission of packets from source terminal devices to destination terminal devices according to the address information contained in each packet. For example, a packet transmitted from one terminal device 61 to another terminal device 63 is forwarded by four switches 100a, 100, 100b, and 100c in that order.

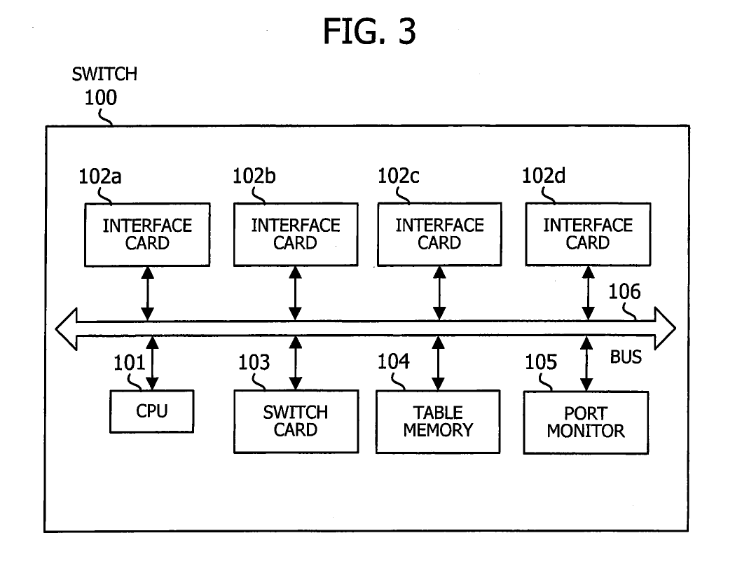

FIG. 3 illustrates a hardware configuration of a switch according to the second embodiment. While FIG. 3 depicts only one switch 100, the illustrated internal structure may be applied to the other switches 100a, 100b, 100c, and 100d as well. Specifically, the illustrated switch 100 includes a CPU 101, interface cards 102a, 102b, 102c, and 102d, a switch card 103, a table memory 104, a port monitor 105, and a bus 106.

The CPU 101 controls the entire system of the switch 100 by executing programs encoded therefor. More specifically, the CPU 101 is coupled to a memory (not illustrated) that stores programs and data. The CPU executes the stored programs by using the stored data. While not depicted in FIG. 3, there is a communication interface for use by the CPU 101. Via this communication interface, the CPU 101 receives commands from the administrator's terminal device 40 and sends execution results back to the terminal device 40.

The table memory 104 may contain a plurality of tables. For example, one table may be used to manage network links and their topology. Another table may be used to make forwarding decisions of each frame. Yet another table may store information indicating destinations of frames.

The bus 106 interconnects the CPU 101, interface cards 102a, 102b, 102c, and 102d, switch card 103, table memory 104, and port monitor 105. The interface cards 102a, 102b, 102c, and 102d have a plurality of communication ports (e.g., eight ports in each card), and each port accommodates one physical link. Those interface cards 102a, 102b, 102c, and 102d watch their respective communication ports to obtain frames from their data traffic. Each interface card 102a, 102b, 102c, and 102d may have an internal buffer(s) (not illustrated) as temporary storage of frames in order to be ready for concurrent reception of frames at two or more communication ports. The interface cards 102a, 102b, 102c, and 102d supply the obtained frames to the switch card 103 via the bus 106.

The switch card 103 has a table of frame destinations. More specifically, the switch card 103 stores, in table form, a collection of information items associated with each other. Each table entry indicates the source address of incoming frames and the identifier of a communication port or logical link used to receive those frames. When a frame is supplied from one of the interface cards 102a, 102b, 102c, and 102d, the switch card 103 makes a forwarding decision (i.e., determines the destination) for the received frame, with reference to the above-noted table. In the case where the determined destination is a logical link, the switch card 103 further consults the aforementioned tables in the table memory 104 to select a specific interface card 102a, 102b, 102c, or 102d and a specific communication port for forwarding the frame. The switch card 103 then forwards the frame to the selected interface card 102a, 102b, 102c, or 102d for transmission. The receiving interface card 102a, 102b, 102c, and 102d outputs the received frame to its destination via the selected communication port.

The port monitor 105 supervises the communication ports on the interface cards 102a, 102b, 102c, and 102d. Each communication port accommodates a physical link. Upon detection of a failure in a physical link, or recovery from the same, the port monitor 105 informs the CPU 101 of that event.

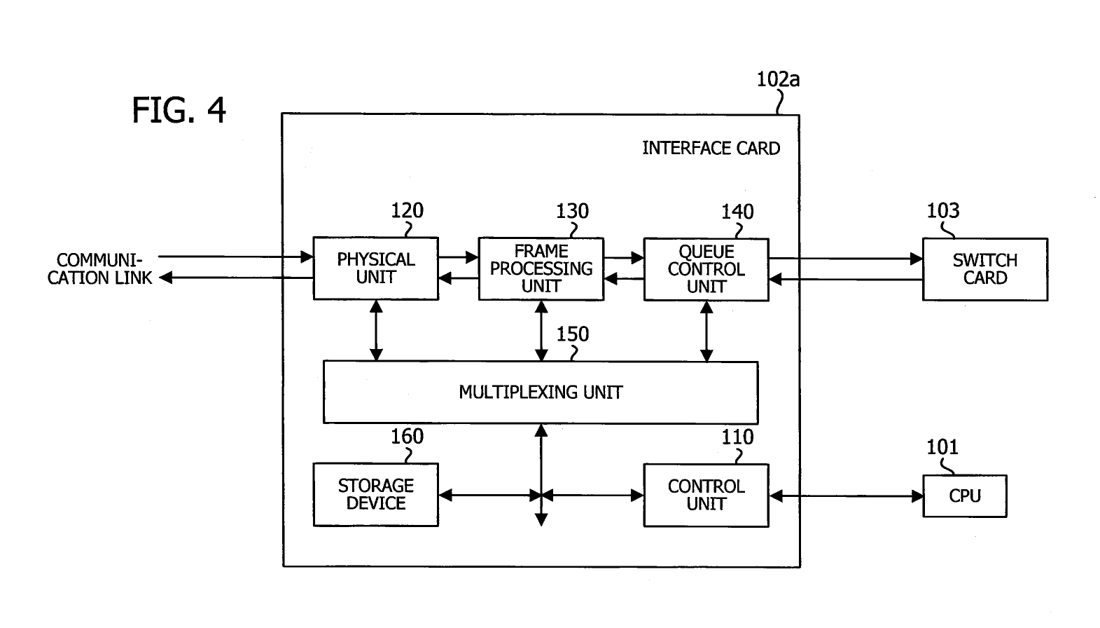

FIG. 4 illustrates a structure of an interface card according to the second embodiment. Specifically, FIG. 4 depicts an exemplary internal structure of the interface card 102a as part of the switch 100 according to the second embodiment. While FIG. 4 illustrates only one interface card 102a, the same structure may similarly be applied to the other interface cards 102b, 102c, and 102d.

According to the second embodiment, the interface card 102a includes a control unit 110, a physical unit 120, a frame processing unit 130, a queue control unit 140, a multiplexing unit 150, and a storage device 160. The interface card 102a is coupled to the CPU 101 and switch card 103 described in FIG. 3.

The control unit 110 controls each component constituting the interface card 102a. The physical unit 120 terminates the physical layer connection of each port on the interface card 102a. Through this physical port, user data is received and transmitted in frame form, so that the data is transported over the network with which the switch 100 is connected. The network may use statistical multiplexing techniques to deliver data.

The frame processing unit 130 executes MAC-layer protocols at each receive port on the interface card 102a, besides making forwarding decisions. The queue control unit 140 controls the flow rate of frame traffic by using traffic policing or traffic shaping techniques.

The multiplexing unit 150 updates statistical data values stored in the storage device 160 with new statistical data values collected by the frame processing unit 130 and queue control unit 140. The storage device 160 is a data storage device where statistical data values are stored. The storage device 160 may be implemented with random access memory (RAM) or flash memory or both.

According to the second embodiment, the interface card 102a receives and retransmits frames after processing them at wire rate with its physical unit 120, frame processing unit 130, and queue control unit 140. For example, the frame processing unit 130 collects MAC-related statistical data values for each port. Also collected are statistical data values related to specific service flows of, for example, virtual local area network (VLAN)/multi-protocol label switching (MPLS). The queue control unit 140, on the other hand, collects statistical data values specific to each policing flow, as well as those specific to each shaping flow. Every time an input frame or output frame passes through those functional blocks, relevant statistical data values are collected and updated. The statistical data values collected in the interface card 102a and other interface cards are supplied to the CPU 101. The CPU 101 summarizes and manages them as statistical data records of the switch 100 as a whole.

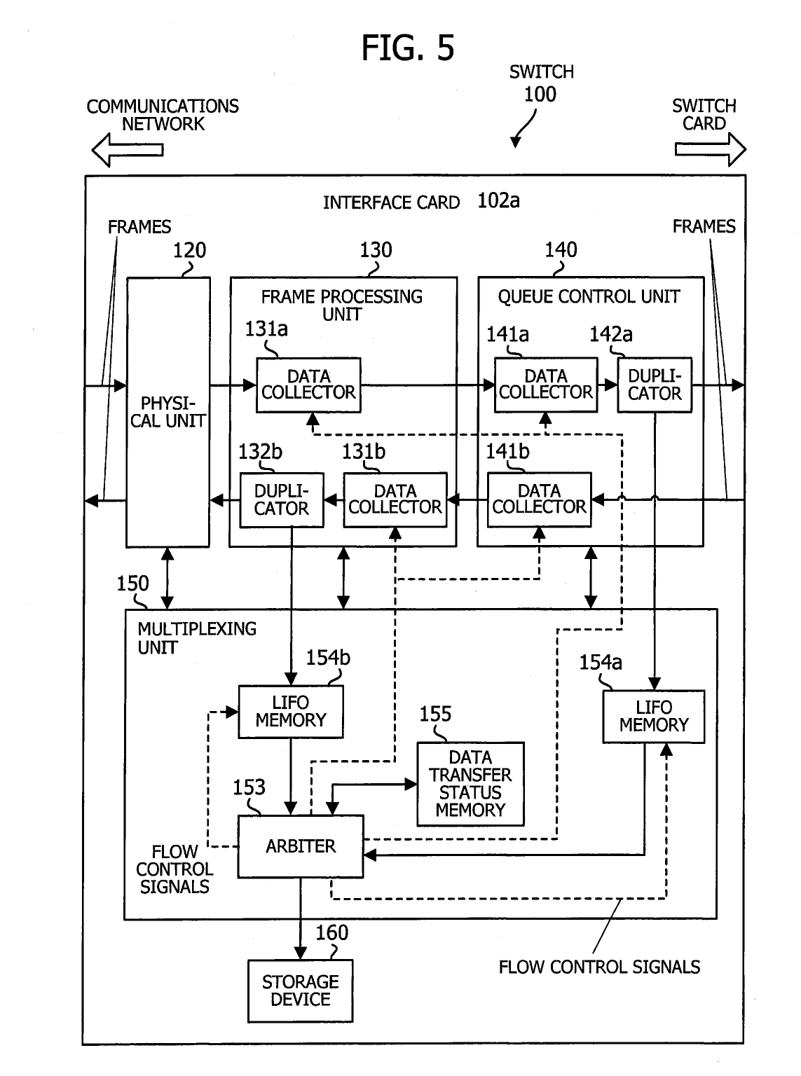

FIG. 5 is a functional block diagram of the interface card according to the second embodiment. It is noted that the second embodiment offers hardware-based control functions to collect statistical data values from each frame that enters the interface card 102a in the switch 100. The collected statistical data values are duplicated and compiled as a statistics transmission data frame, which is then transferred to a storage device 160. Existing statistical data values in the storage device 160 are then updated with new statistical data values provided by the transferred statistics transmission data frame, under the software-based control.

As described previously in FIG. 4, the interface card 102a of the second embodiment includes a physical unit 120, a frame processing unit 130, a queue control unit 140, a multiplexing unit 150, and a storage device 160. These components are also seen in FIG. 5. Referring to FIG. 5, the frame processing unit 130 includes data collectors 131a and 131b and a duplicator 132b. Similarly the queue control unit 140 includes data collectors 141a and 141b and a duplicator 142a. The multiplexing unit 150 includes an arbiter 153, last-in first-out (LIFO) memories 154a and 154b, and a data transfer status memory 155.

User data frames arrive at the interface card 102a of the switch 100. The data collectors 131a, 131b, 141a, and 141b collect a plurality of statistical data values describing communication activities, based on those user data frames. The data collectors 131a, 131b, 141a, and 141b add a management ID to each of the collected statistical data values, thus producing a statistics transmission data frame. These features enable the switch 100 to collect a plurality of statistical data values from the received frames and transmit the collected statistical data values all together to the storage device 160. The processing load on the switch 100 may therefore be reduced.

In the frame processing unit 130, one data collector 131a obtains statistical data values from each frame that arrives at the physical unit 120 from a communication link connected to the interface card 102a. The data collector 131a collects such statistical data values. Another data collector 131b in the frame processing unit 130 obtains statistical data values from each frame transferred from the switch card 103.

In the queue control unit 140, one data collector 141a obtains statistical data values from each frame that arrives at the physical unit 120 from a communication link connected to the interface card 102a. Another data collector 141b in the queue control unit 140 obtains statistical data values from each frame transferred from the switch card 103.

The data collectors 131a and 131b collect statistical data values MAC-related statistical data values, as well as statistical data values specific to each service flow of VLAN/MPLS and the like. The data collectors 141a and 141b, on the other hand, collect statistical data values specific to each policing flow, as well as those specific to each shaping flow.

The duplicator 142a is supplied with statistical data values that the data collectors 131a and 141a have collected from the received frames (i.e., the frames received by the interface card 102a from a communication link). The duplicator 142a adds a management ID to each statistical data value and compiles them into a single statistics transmission data frame. The resulting statistics transmission data frame thus contains a plurality of statistical data values. The statistics transmission data frame also contains management IDs associated with its constituent statistical data values for management purposes. Those management IDs indicate what statistical data values are to be updated with each specific statistical data value in a given statistics transmission. The management IDs further indicate which one of the statistical data values stored in the storage device 160 is to be updated with each specific statistical data value in a given statistics transmission data frame.

The duplicator 132b is supplied with statistical data values that the data collectors 131b and 141b have collected on the basis of frames supplied from the switch card 103. The duplicator 132a compiles those statistical data values into a single statistics transmission data frame, while adding a management ID to each statistical data value. The two duplicators 132b and 142a produce such statistics transmission data frames at the same speed as the interface card 102a receives frames. It is noted that the duplicators 132b and 142a may remove the payload field of frames when they produce a statistics transmission data frame, thereby reducing the amount of data to be stored in LIFO memories 154a and 154b (described later). The above-described data collectors 131a, 131b, 141a, and 141b, and duplicators 132b and 142a collectively function as the foregoing collection unit 1a of the first embodiment.

The multiplexing unit 150 includes an arbiter 153 to transfer statistics transmission data frames produced by the above data collectors 131a, 131b, 141a, and 141b to the storage device 160 by using a direct memory access technique. Statistical data values in each statistics transmission data frame are thus written into the storage device 160 with hardware-based processing. The multiplexing unit 150 functions as the control unit 1b discussed in the first embodiment.

Upon receipt of a user data frame relevant to statistics transmission data corresponding to a specific management data tag, the arbiter 153 stores a transfer status flag in the data transfer status memory 155 to indicate that the statistics transmission data corresponding to the management data tag has not been transferred. Upon completion of transferring statistics transmission data in the LIFO memories 154a and 154b to the storage device 160, the arbiter 153 stores a transfer status flag in the data transfer status memory 155 to indicate the completion of transferring of the statistics transmission data. Such transfer status flags may also be referred to as transfer status information.

Statistics transmission data is written into and read out of the LIFO memories 154a and 154b in a last-in first-out fashion. The arbiter 153 causes a newly produced statistics transmission data frame to enter the LIFO memories 154a and 154b for the time being, so that the stored statistics transmission data frames will be read out of the LIFO memories 154a and 154b and transferred later to their destinations. This feature enables adjustment of the timing of transferring statistics transmission data frames. That is, statistics transmission data frames are produced at the same speed as the interface card 102a receives frames, and thus written into the LIFO memories 154a and 154b at that speed. Here the LIFO memories 154a and 154b are used to adjust the timing of DMA transfer of statistics transmission data frames to the storage device 160. The write data rate to the LIFO memories 154a and 154b may be as high as the total bandwidth of physical links accommodated by the interface card 102a. For example, the total bandwidth reaches 20 Gbps in the case where the interface card 102a accommodates 20 ports with a bandwidth of 1 Gbps for each.

One LIFO memory 154a stores statistics transmission data frames produced from input frames that the interface card 102a receives from a communications network. Another LIFO memory 154b stores statistics transmission data frames produced from outgoing frames that are supplied from the switch card 103 to the interface card 102a. When transferring data to the storage device 160, the arbiter 153 provides flow control signals as internal signals that indicate which of the two LIFO memories 154a and 154b is supposed to provide statistics transmission data frames.

According to the second embodiment, the read data rate from LIFO memories 154a and 154b is lower than the write data rate to the same. This means that some of the pending statistics transmission data frames may possibly be discarded in the LIFO memories 154a and 154b. From the viewpoint of keeping statistical data values up to date, the statistical data values in a new statistics transmission data frame is more important than those in an old statistics transmission data frame with the same management ID. This is why the second embodiment preferably uses LIFO memories 154a and 154b. It is not intended, however, to limit the second embodiment by this specific choice of memory type. For example, the second embodiment may be modified to use first-in first-out (FIFO) cache memories.

When reading a statistics transmission data frame from either of the LIFO memories 154a and 154b, the arbiter 153 performs CPU bus arbitration in such a way that the read operation for statistical data values and other software-based activities will share the CPU bus in an appropriate ratio. The LIFO memories 154a and 154b have to be large enough to store at least one record for every kind of statistical data values to be stored.

The data transfer status memory 155 stores transfer status flags that indicate whether the statistics transmission data corresponding to each management data tag has been transferred to the storage device 160. Those transfer status flags permit the arbiter 153 to know the completion or incompletion of data transfer for a specific statistics transmission data frame to the storage device 160.

The storage device 160 stores each statistical data value according to its corresponding management data tag, based on statistics transmission data frames transferred from the multiplexing unit 150.

According to the second embodiment, the interface card 102a obtains various statistical data values from given frames and stores them in the storage device 160. Specifically, those statistical data values include the following items: the number of transmitted unicast frames, the number of received unicast frames, the number of transmitted multicast frames, the number of received multicast frames, the number of transmitted broadcast frames, the number of received broadcast frames, the number of transmitted PAUSE frames (frames indicating buffer status), the number of received PAUSE frames, the number of bytes of outgoing frames, the number of bytes of received frames, the number of transmitted frames with specific lengths, the number of received frames with specific lengths, the number of transmitted normal frames, the number of received normal frames, the number of outgoing frames that are discarded, and the number of received frames that are discarded. These statistical data values may be summarized on an individual port basis, or an individual service basis, or an individual flow basis. It is noted that the statistical data values enumerated above are only an example. In actual implementations, the interface cards may be designed to collect a subset of the above items, or may be enhanced to collect more data items than the above.

According to the second embodiment, statistical data is updated in response to entry of a new frame to the interface card 102a. Specifically, statistical data values may be updated as necessary by using a direct memory access method (i.e., by hardware control) at the same pace as their source frames passing through the switch 100. Besides being managed by software, those statistical data values are constantly updated by hardware. It is therefore possible for software applications to read the latest statistical data values at any time. These features reduce the chance of overflow of temporary memory storing statistical data values, thus eliminating or alleviating the need for reading them at short time intervals.

The above features also prevent the CPU bus from being occupied too much by software-based control processing, thus alleviating the load on the switch 100. The reduced chance of memory overflow also leads to relaxed capacity requirements for the LIFO memories 154a and 154b.

The interface card 102a of the second embodiment transfers frames from communication links to the switch card 103. The interface card 102a also transfers frames from the switch card 103 to communication links. For the former group of frames, the data collectors 131a and 141a collect statistical data values, and their downstream duplicator 142a compiles those records into a statistical transmission data frame. For the latter group of frames, the data collectors 141b and 131b collect statistical data values, and their downstream duplicator 132b compiles them into a statistics transmission data frame.

The statistics transmission data frames produced by the duplicators 132b and 142a are then transferred over the CPU control bus to the storage device 160, under the control of the arbiter 153 in the multiplexing unit 150. It is noted here that one input frame may possibly produce updates to two or more statistical data values. When this is the case, the statistics transmission data frame contains a plurality of statistical data values and their respective management IDs. When that is not the case (i.e., when one input frame produces only one update), the statistics transmission data frame contains one statistical data value and one management ID for that input frame.

The second embodiment implements LIFO memories 154a and 154b as part of the multiplexing unit 150. This implementation is advantageous in that their control signals and related circuits can be integrated into the multiplexing unit 150.

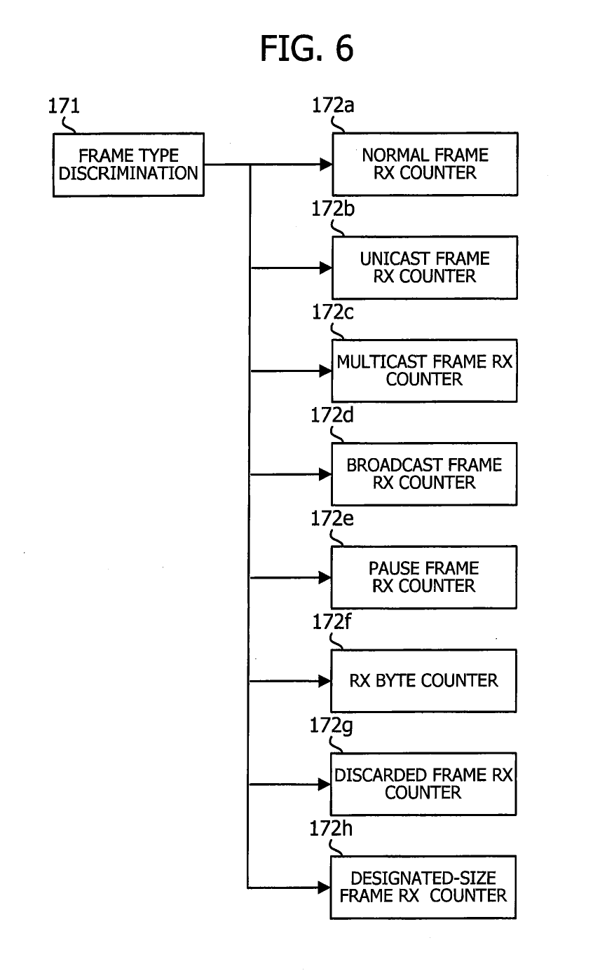

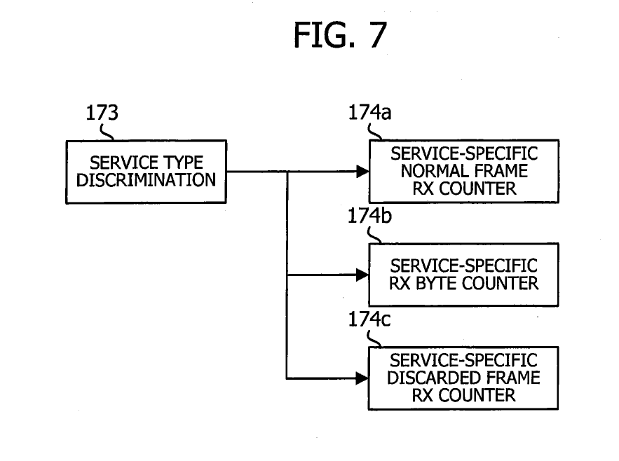

FIGS. 6 and 7 illustrate two groups of counters used to count received frames according to the second embodiment. According to the second embodiment, input frames that arrives at the interface card 102a from a communication link are subjected to ingress processing, and statistical data values are collected from those frames separately for each different port, as well as for each different service flow. The frame processing unit 130 and queue control unit 140 include a plurality of counters for the purpose of obtaining and keeping such statistical data values. Specifically, the switch 100 according to the second embodiment includes a group of counters illustrated in FIG. 6 to obtain port-by-port statistical data values from received frames. This group includes the following counters: normal frame reception (Rx) counters 172a, unicast frame Rx counters 172b, multicast frame Rx counters 172c, broadcast frame Rx counters 172d, PAUSE frame Rx counters 172e, Rx byte counters 172f, discarded frame Rx counters 172g, and designated-size frame Rx counters 172h.

More specifically, the normal frame Rx counters 172a count the number of MAC frames that are received properly (hence “normal”) at each corresponding port. The unicast frame Rx counters 172b count, for each corresponding port, the number of received normal MAC frames having a unicast destination MAC address. The multicast frame Rx counters 172c count, for each corresponding port, the number of received normal MAC frames having a multicast destination MAC address. The broadcast frame Rx counters 172d count, for each corresponding port, the number of received normal MAC frames having a broadcast destination MAC address. The PAUSE frame Rx counters 172e count, for each corresponding port, the number of received normal MAC frames that serve as PAUSE frames in network flow control. PAUSE frames are used to inform the recipients that the switch is unable to provide a sufficient buffer space for transferring frames properly. The Rx byte counters 172f count, for each corresponding port, the number of bytes of normal MAC frames that are received. The discarded frame Rx counters 172g count, for each corresponding port, the number of received MAC frames that are discarded because of their anomalies such as MAC error and frame check sequence (FCS) error. The designated-size frame Rx counters 172h count, for each corresponding port, the number of received normal MAC frames whose lengths fall within a designated range (e.g., from N bytes to M bytes).

Received frames are subjected to frame type discrimination processing 171 in the frame processing unit 130 and queue control unit 140 of each port. This processing discriminates the type of each received frame in various aspects to determine its relevance to the above-described normal frame Rx counters 172a, unicast frame Rx counters 172b, multicast frame Rx counters 172c, broadcast frame Rx counters 172d, PAUSE frame Rx counters 172e, Rx byte counters 172f, discarded frame Rx counters 172g, and designated-size frame Rx counters 172h. Those counters are incremented by one (or by the number of bytes constituting a received frame in the case of Rx byte counters 172f) when a relevant frame is found at their corresponding ports.

The switch 100 also includes another group of counters illustrated in FIG. 7 to obtain service-by-service statistical data values from received frames. This group includes the following counters for different service flows: service-specific normal frame Rx counters 174a, service-specific Rx byte counters 174b, and service-specific discarded frame Rx counters 174c.

More specifically, the service-specific normal frame Rx counters 174a count, for each corresponding service, the number of normal MAC frames that are received properly. The service-specific Rx byte counters 174b count, for each specific service, the number of bytes of normal MAC frames that are received. The service-specific discarded frame Rx counters 174c count, for each corresponding service, the number of received MAC frames that are discarded because of their anomalies such as MAC error and FCS error.

Received frames are subjected to service type discrimination processing 173 in the frame processing unit 130 and queue control unit 140. This processing discriminates the service type of each received frame to determine its relevance to the above-described service-specific normal frame Rx counter 174a, service-specific Rx byte counter 174b, and service-specific discarded frame Rx counter 174c. These counters are incremented by one (or by the number of bytes constituting a received frame in the case of service-specific Rx byte counter 174b) when a relevant frame is found with their corresponding service.

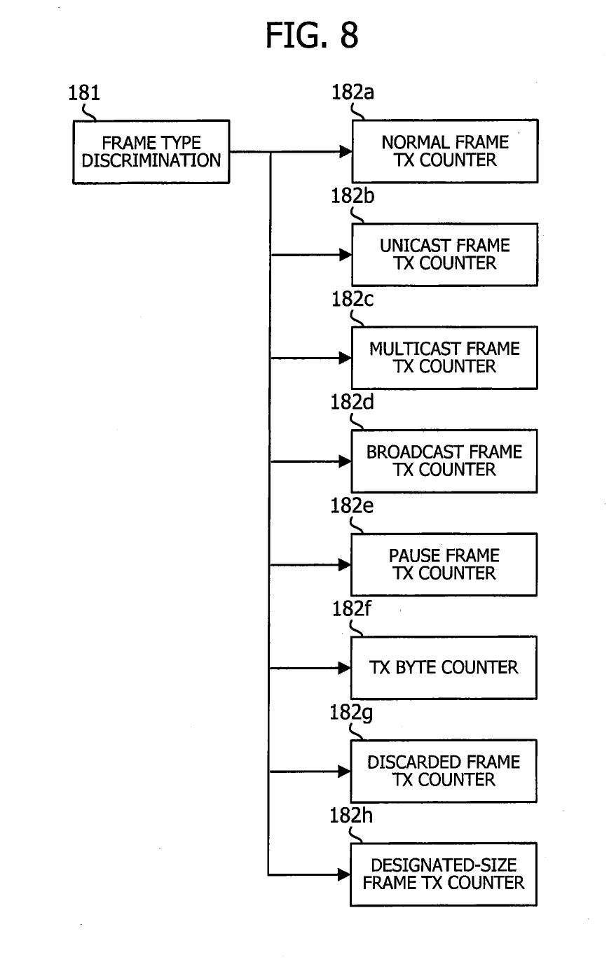

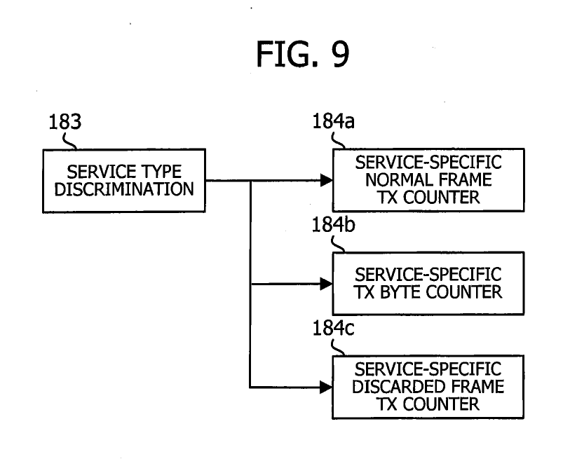

FIGS. 8 and 9 illustrate two collections of counters used for transmitted or outgoing frames according to the second embodiment. According to the second embodiment, outgoing frames supplied from the switch card 103 are subjected to egress processing before they are transmitted from the switch 100. Similarly to the received frames discussed above in FIGS. 6 and 7, statistical data values are collected from outgoing frames separately for each different port, as well as for each different service flow. The frame processing unit 130 and queue control unit 140 include a plurality of counters for the purpose of obtaining and keeping such statistical data values. Specifically, the switch 100 according to the second embodiment includes a group of counters illustrated in FIG. 8 to obtain port-by-port statistical data values from outgoing frames. This group includes the following counters: normal frame transmission (Tx) counters 182a, unicast frame Tx counters 182b, multicast frame Tx counters 182c, broadcast frame Tx counters 182d, PAUSE frame Tx counters 182e, Tx byte counters 182f, discarded frame Tx counters 182g, and designated-size frame Tx counters 182h.

More specifically, the normal frame Tx counters 182a count the number of MAC frames that are transmitted properly (hence “normal”) from each corresponding port. The unicast frame Tx counters 182b count, for each corresponding port, the number of normal MAC frames transmitted with a unicast destination MAC address. The multicast frame Tx counters 182c count, for each corresponding port, the number of normal MAC frames transmitted with a multicast destination MAC address. The broadcast frame Tx counters 182d count, for each corresponding port, the number of normal MAC frames transmitted with a broadcast destination MAC address. The PAUSE frame Tx counters 182e count, for each corresponding port, the number of normal MAC frames transmitted as PAUSE frames for network flow control. PAUSE frames are used to inform the recipients that the switch is unable to provide a sufficient buffer space for transferring frames properly. The Tx byte counters 182f count, for each corresponding port, the number of bytes of normal MAC frames that are transmitted. The discarded frame Tx counters 182g count, for each corresponding port, the number of outgoing MAC frames that are discarded before transmission because of their anomalies such as MAC error and FCS error. The designated-size frame Tx counters 182h count, for each corresponding port, the number of transmitted normal MAC frames whose lengths fall within a designated range (e.g., from N bytes to M bytes).

Outgoing frames are subjected to frame type discrimination processing 181 in the frame processing unit 130 and queue control unit 140 of each port. This processing discriminates the type of each outgoing frame in various aspects to determine its relevance to the above-described normal frame Tx counter 182a, unicast frame Tx counter 182b, multicast frame Tx counter 182c, broadcast frame Tx counter 182d, PAUSE frame Tx counter 182e, Tx byte counter 182f, discarded frame Tx counter 182g, and designated-size frame Tx counter 182h. Those counters are incremented by one (or by the number of bytes constituting a received frame in the case of Tx byte counters 182f) when a relevant frame is found at their corresponding ports.

The switch 100 also includes another group of counters illustrated in FIG. 9 to obtain service-by-service statistical data values from outgoing frames. This group includes the following counters: service-specific normal frame Tx counters 184a, service-specific Tx byte counters 184b, and service-specific discarded frame Tx counters 184c

More specifically, the service-specific normal frame Tx counters 184a count, for each corresponding service, the number of normal MAC frames that are transmitted. The service-specific Tx byte counters 184b count, for each corresponding service, the number of bytes of normal MAC frames that are transmitted. The service-specific discarded frame Tx counters 184c count, for each corresponding service, the number of outgoing MAC frames that are discarded before transmission because of their anomalies such as MAC error and FCS error.

Outgoing frames are subjected to service type discrimination processing 183 in the frame processing unit 130 and queue control unit 140. This processing discriminates the service type of each outgoing frame to determine its relevance to the above-described service-specific normal frame Tx counter 184a, service-specific Tx byte counter 184b, and service-specific discarded frame Tx counter 184c. Those counters are incremented by one (or the number of bytes constituting a received frame in the case of service-specific Tx byte counter 184b) when a relevant frame is found with their corresponding service.

It is noted that the counters enumerated above in FIGS. 6-8 are only an example. In actual implementations, the interface card may have a subset of the above counters, or may have more counters than the above. The following section will now describe how the second embodiment collects statistical data values.

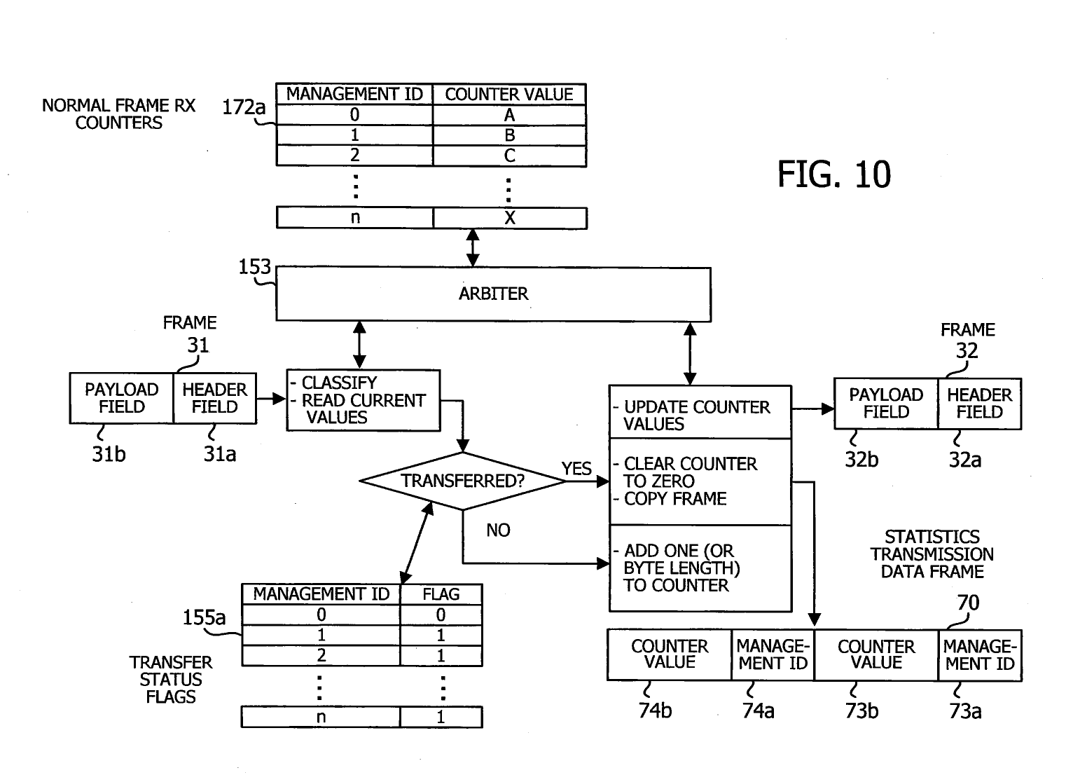

FIG. 10 illustrates operation of some counters according to the second embodiment. Specifically, FIG. 10 illustrates how the normal frame Rx counters work when an interface card 102a in the switch 100 collects statistical data values concerning the number of frames. While FIG. 10 depicts only one counter, i.e., normal frame Rx counter 172a, the person skilled in the art would appreciate that the following description similarly applies to the other counters.

Referring to FIG. 10, the illustrated interface card 102a of the second embodiment receives frames from a communication link, as well as from a switch card 103. Suppose, for example, that a frame 31 formed from a header field 31a and a payload field 31b is received. While not depicted in detail, the header field 31a of this frame 31 contains, for example, input/output port number, source MAC address, destination MAC address, VLAN tag, and MPLS information. With those control parameters in the input frame 31, the data collector 131a or 131b determines one or more management IDs that indicate which statistical data values have to be updated.

Based on the management IDs determined above, the arbiter 153 obtains the current counter values from the normal frame Rx counter 172a and others in the frame processing unit 130 and queue control unit 140. The arbiter 153 then turns to the data transfer status memory 155 and consults transfer status flags 155a stored therein to determine the progress of DMA transfer of statistics transmission data. More specifically, the arbiter 153 obtains a DMA status flag corresponding to a specific management ID.

The transfer status flags 155a are provided for different specific management IDs, each indicating whether its corresponding statistical data values have been transferred to the storage device 160 by the arbiter 153. Those transfer status flags 155a may be stored in the arbiter 153 itself, or may be stored in some other storage location accessible to the arbiter 153.

The arbiter 153 reads a transfer status flag 155a corresponding to a management ID, which indicates progress of relevant data transfer of a statistical data value. If the transfer status flag 155a corresponding to one management ID has a value (e.g., “1”) indicating that the statistical data value in question is still in process of transfer to the storage device 160, the arbiter 153 updates a relevant counter in the frame processing unit 130 and queue control unit 140, without producing a statistics transmission data frame 70.

The counters are updated as follows when the transfer of statistical data values is pending. Specifically the arbiter 153 reads out a relevant counter and increments its value by one or by the number of bytes of the input frame, depending on whether the counter counts frames or bytes. The arbiter 153 writes the resulting sum back to the counter. The interface card 102a, on the other hand, outputs a frame 32 that is formed from a header field 32a and a payload field 32b, which carry the same values as the header field 31a and payload field 31b, respectively.

When, on the other hand, the transfer status flag 155a has a value (e.g., “0”) indicating completion of data transfer, it means that the statistical data value in the storage device 160 is in an up-to-date state. The arbiter 153 therefore initializes the corresponding counter to zero. The arbiter 153 further produces a statistics transmission data frame 70 by duplicating (as will be described later). This statistics transmission data frame 70 contains a plurality of statistical data values, as well as a plurality of management IDs for management of the statistical data values. For example, the illustrated statistics transmission data frame 70 has data fields for counter values 73b and 74b (statistical data values) and their respective management IDs 73a and 74a. The arbiter 153 increments the read value of the counter by one (or by the byte length of the received frame 31, where applicable), puts the resulting value in the counter value field 73b, and transfers it, together with its management ID 73a, to the storage device 160 via the CPU control bus. The arbiter 153 thus avoids generation of unnecessary statistics transmission data frames even when a new frame 31 arrives at the interface card 102a during transfer of statistics transmission data frames, besides preventing a single frame from being counted twice.

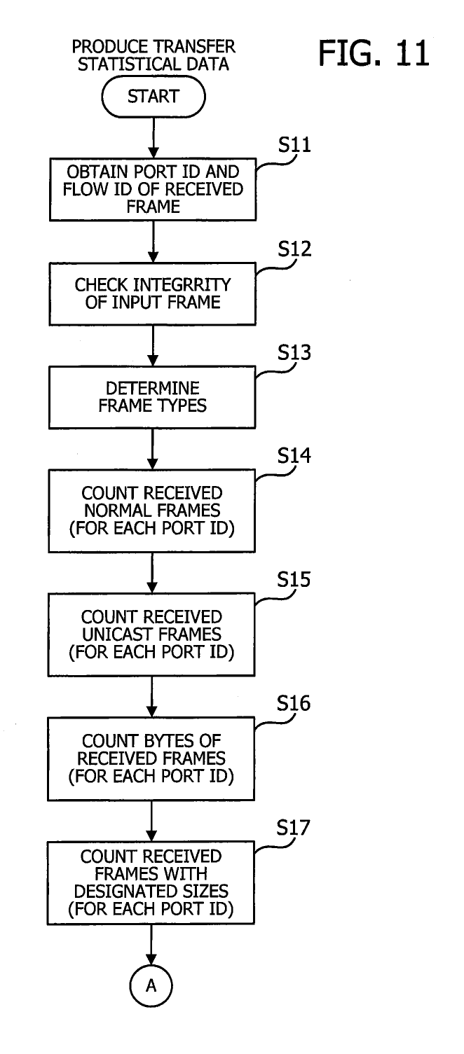

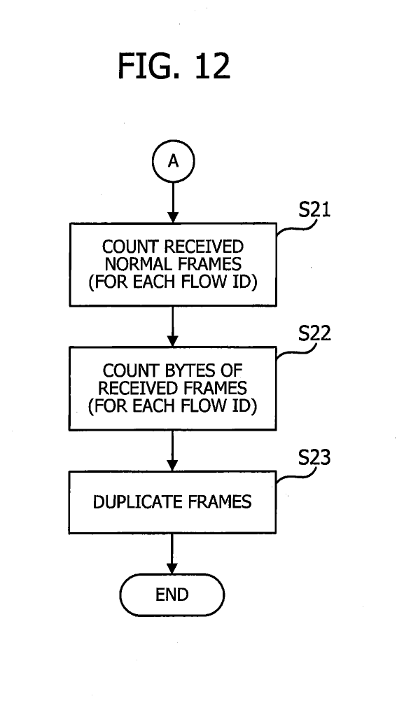

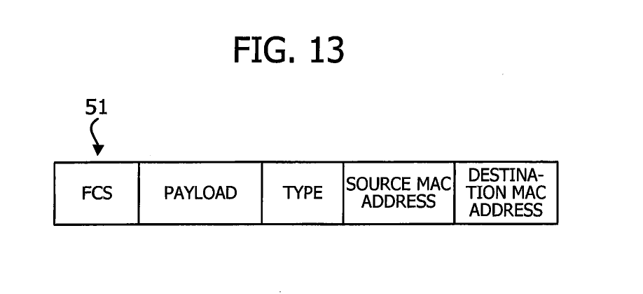

The second embodiment executes a control process as follows. FIGS. 11 and 12 are a flowchart illustrating a process of generating statistics transmission data according to the second embodiment. The process of FIGS. 11 and 12 is executed by an interface card 102a to collect statistical data values from received frames by using counters and produce a statistics transmission data frame from the collected values. This execution takes place when there are input frames to the interface card 102a. It is assumed in FIGS. 11 and 12 (as well as FIGS. 13 to 21 for this matter) that a 64-byte unicast frame is subjected, as an input frame, to the ingress processing. The person skilled in the art would appreciate that the following description can similarly be applied to other kinds of frames, and also to the egress processing of frames.

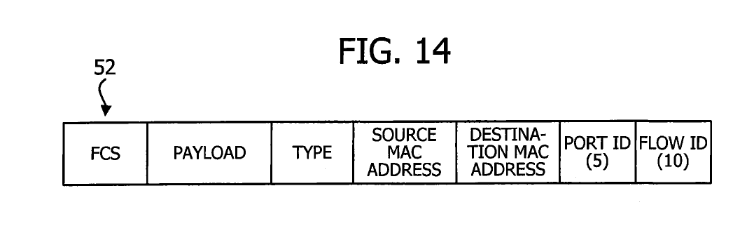

(Step S11) The data collector 131a obtains port ID and flow ID of an input frame on the basis of control parameters of that frame. In the present example, the interface card 102a has received a frame 51 seen in FIG. 13 from a communication link. It is assumed here that the data collector 131a obtains a port ID of “5” and a flow ID of “10” from the frame 51. The duplicator 142a then adds the obtained port ID and flow ID to the frame 51. The resulting frame 52 is seen in FIG. 14.

(Step S12) The data collector 131a checks the integrity of the input frame. For example, this check may examine the frame in question in the following aspects: FCS errors, plausibility of MAC address (e.g., the frame is incorrect when it carries a multicast address in its source MAC address field), and anomalies in the Type value and frame length.

(Step S13) The data collector 131a determines the frame types of the input frame. For example, this frame type determination may test whether the input frame 51 is a unicast frame, multicast frame, or broadcast frame. It is also tested whether the frame 51 is a PAUSE frame.

The following steps S14 to S22 assume the frame to be a unicast frame and thus update its relevant counters out of those seen in FIGS. 6 to 9. This is, however, only an example. Steps S14 to S22 may actually update different counters depending on the determination result of step S13 for the frame received by the switch 100.

(Step S14) When the input frame has no problems in its integrity, the data collector 131a increments by one the normal frame Rx counter 172a corresponding to the port ID obtained at step S11.

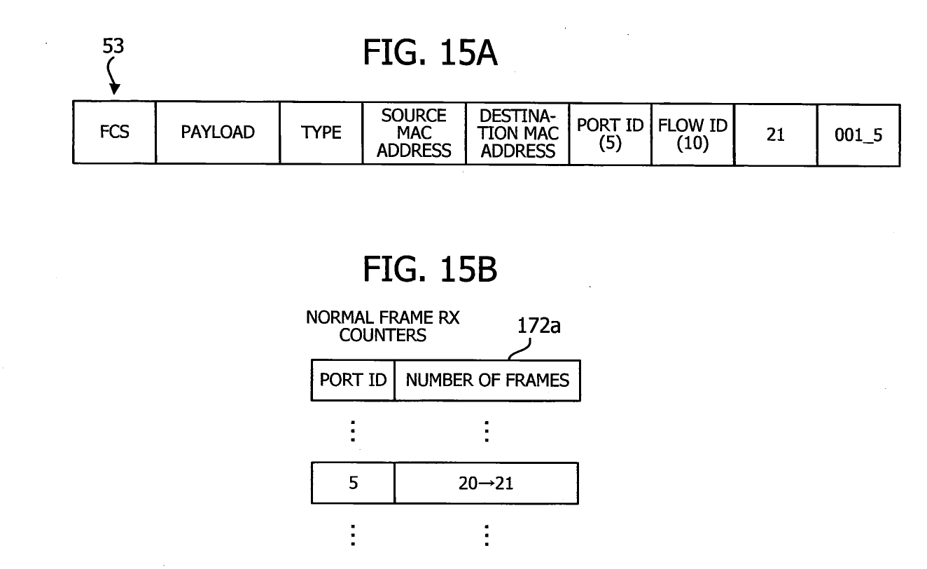

Referring here to FIGS. 15A and 15B, the operation of this step S14 will be explained with a specific example. The storage device 160 has a memory area (not illustrated) to store statistical data values corresponding to normal frame Rx counters 172a, with a number “001” assigned to uniquely distinguish it from other memory areas. Since the normal frame Rx counters 172a are provided on an individual port basis, those statistical data values are each given a statistical data ID in the form of, for example, “001_{—}5” where “5” is a port ID. Port ID is used as the index for designating a specific address in the noted memory area. For example, the current value of “20” is read out of the memory address corresponding to port ID “5” and incremented by one. The resulting value “21” is then written back into the same memory address. The duplicator 142a adds this new value “21” to the frame 52 (FIG. 14), together with the statistical data ID “001_{—}5” mentioned above. The result is seen as a frame 53 in FIG. 15A.

(Step S15) The data collector 131a increments by one the unicast frame Rx counter 172b corresponding to the obtained port ID when the input frame is determined to be a unicast frame.

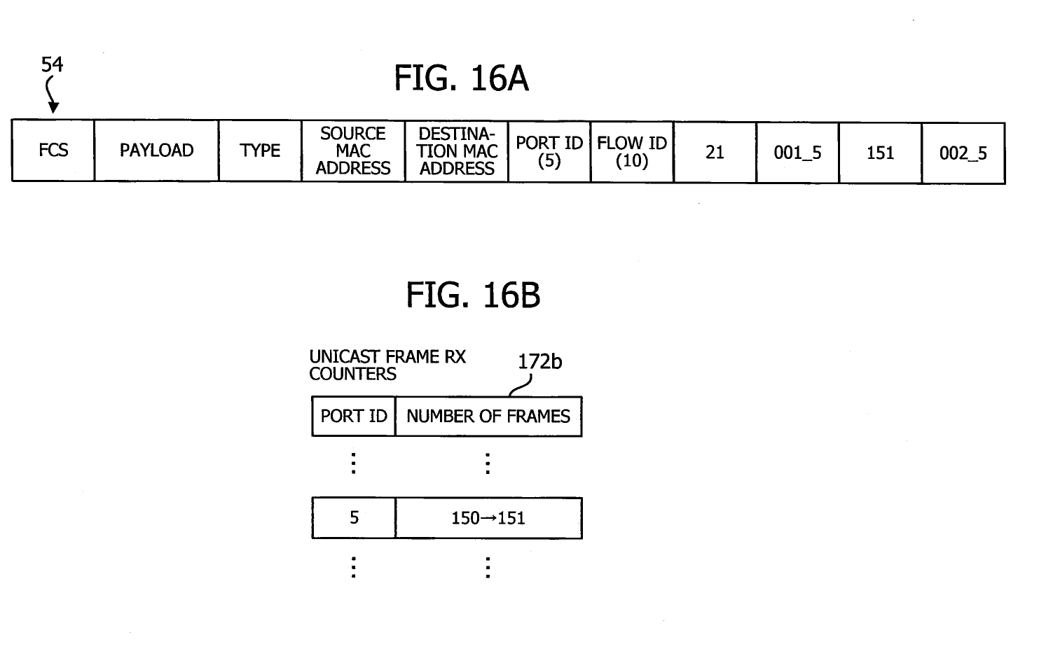

Referring here to FIGS. 16A and 16B, the operation of this step S15 will be explained with a specific example. The storage device 160 has a memory area (not illustrated) to store statistical data values corresponding to unicast frame Rx counters 172b, with a number “002” assigned to uniquely distinguish it from other memory areas. Since the unicast frame Rx counters 172b are provided on an individual port basis, those statistical data values are each given a statistical data ID in the form of, for example, “002_{—}5” where “5” is a port ID. For example, the current value of “150” is read out of the memory address corresponding to port ID “5” and incremented by one. The resulting value “151” is then written back into the same memory address. The duplicator 142a adds this new value “151” to the frame 53 (FIG. 15A), together with the statistical data ID “002_{—}5” mentioned above. The result is seen as a frame 54 in FIG. 16A.

(Step S16) The data collector 131a adds the number of bytes of the input frame to the Rx byte counter 172f corresponding to the obtained port ID.

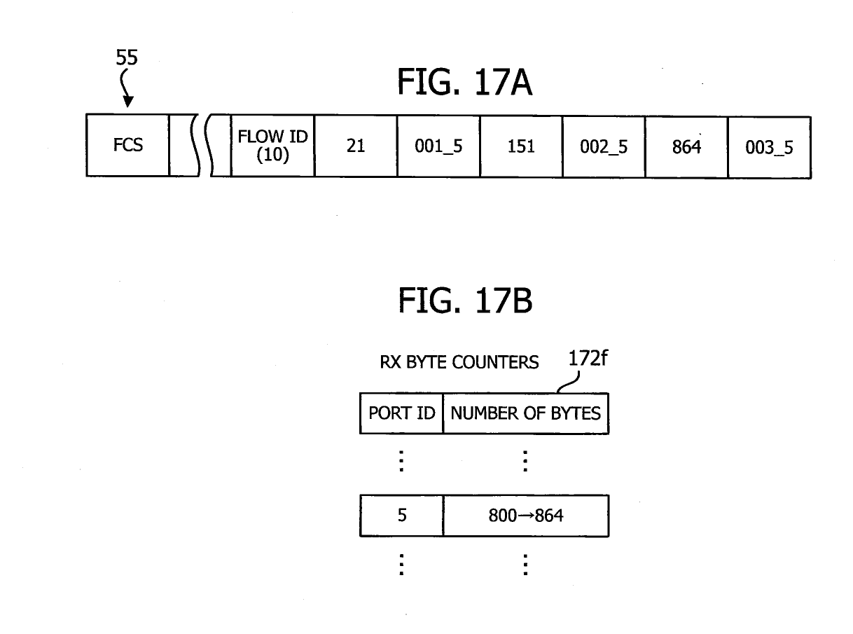

Referring here to FIGS. 17A and 17B, the operation of this step S16 will be explained with a specific example. The storage device 160 has a memory area (not illustrated) to store statistical data values corresponding to Rx byte counters 172f, with a number “003” assigned to uniquely distinguish it from other memory areas. Since the Rx byte counters 172f are provided on an individual port basis, those statistical data values are each given a statistical data ID in the form of, for example, “003_{—}5” where “5” is a port ID. For example, the current value of “800” is read out of the memory address corresponding to port ID “5” and incremented by the number “64” of received bytes. The resulting value “864” is then written back into the same memory address. The duplicator 142a adds this new value “864” to the frame 54 (FIG. 16A), together with the statistical data ID “003_{—}5” mentioned above. The result is seen as a frame 55 in FIG. 17A.

(Step S17) When the size of the input frame falls within a designated range (for example, 64 bytes to 127 bytes), the data collector 131a increments by one the designated-size frame Rx counter 172h corresponding to the obtained port ID.

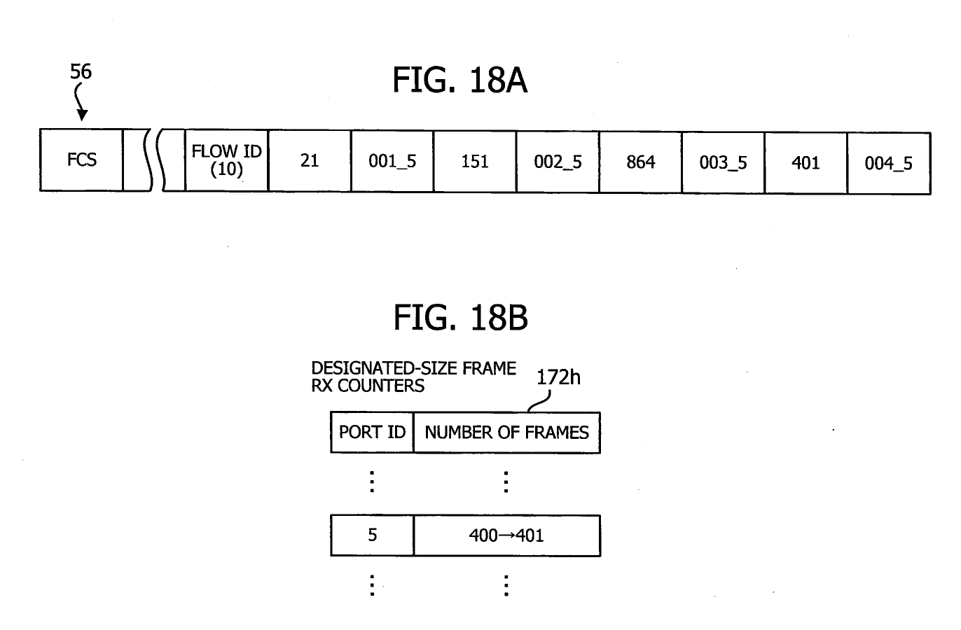

Referring here to FIGS. 18A and 18B, the operation of this step S17 will be explained with a specific example. The storage device 160 has a memory area (not illustrated) to store statistical data values corresponding to designated-size frame Rx counters 172h, with a number “004” assigned to uniquely distinguish it from other memory areas. Since the designated-size frame Rx counters 172h are provided on an individual port basis, those statistical data values are each given a statistical data ID in the form of, for example, “004_{—}5” where “5” is a port ID. For example, the current value of “400” is read out of the memory address corresponding to port ID “5” and incremented by one. The resulting value “401” is then written back into the same memory address. The duplicator 142a adds this new value “401” to the frame 55 (FIG. 17A), together with the statistical data ID “004_{—}5” mentioned above. The result is seen as a frame 56 in FIG. 18A.

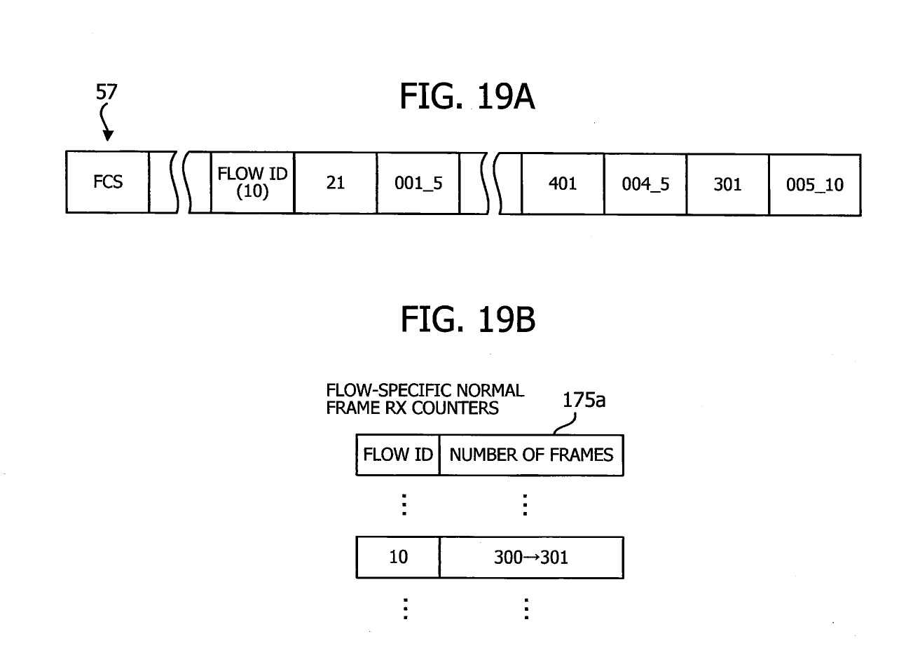

(Step S21) When the input frame has no problems in its integrity, the data collector 131a increments by one the flow-specific normal frame Rx counter 175a (described below in FIG. 19B) corresponding to the flow ID obtained at step S11.

Referring here to FIGS. 19A and 19B, the operation of this step S21 will be explained with a specific example. The storage device 160 has a memory area (not illustrated) to store statistical data values corresponding to flow-specific normal frame Rx counters 175a, with a number “005” assigned to uniquely distinguish it from other memory areas. Since the flow-specific normal frame Rx counters 175a are provided on an individual flow basis, those statistical data values are each given a statistical data ID in the form of, for example, “005_{—}10” where “10” is a flow ID. Flow ID is used as the index for designating a specific address in the noted memory area. For example, the current value of “300” is read out of the memory address corresponding to flow ID “10” and incremented by one. The resulting value “301” is then written back into the same memory address. The duplicator 142a adds this new value “301” to the frame 56 (FIG. 18A), together with the statistical data ID “005_{—}10” mentioned above. The result is seen as a frame 57 in FIG. 19A.

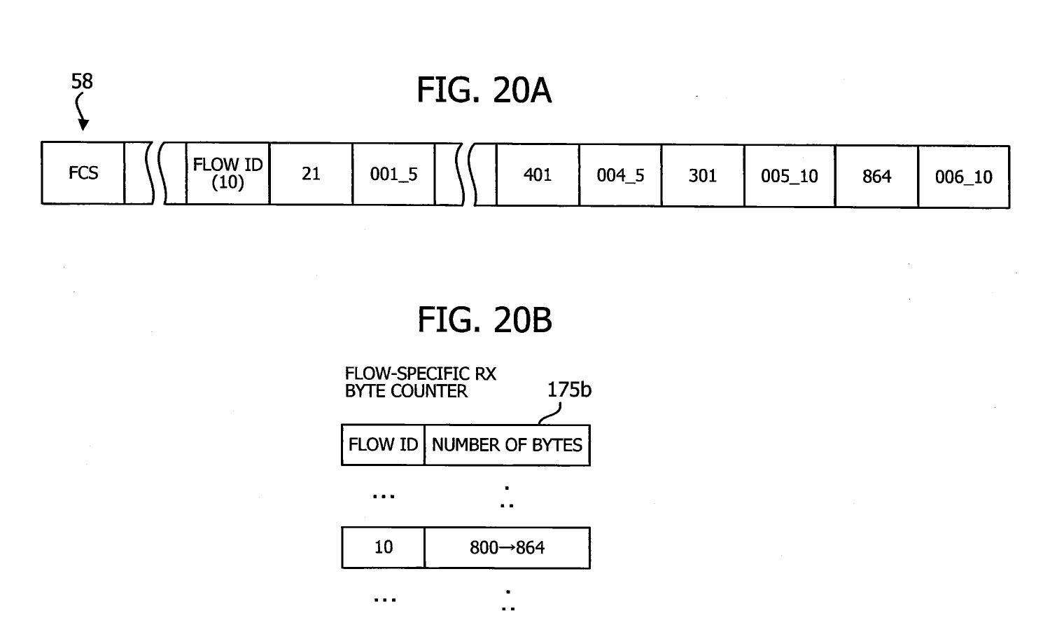

(Step S22) When the input frame is determined to be a unicast frame, the data collector 131a increments by one a flow-specific Rx byte counter 175b (described below in FIG. 20B) that corresponds to the flow ID obtained at step S11.

Referring here to FIGS. 20A and 20B, the operation of this step S22 will be explained with a specific example. The storage device 160 has a memory area (not illustrated) to store statistical data values corresponding to flow-specific Rx byte counters 175b, with a number “006” assigned to uniquely distinguish it from other memory areas. Since the flow-specific Rx byte counters 175b are provided on an individual flow basis, those statistical data values are each given a statistical data ID in the form of, for example, “006_{—}10” where “10” is a flow ID. For example, the current value of “800” is read out of the memory address corresponding to port ID “10” and incremented by the number “64” of received bytes. The resulting value “864” is then written back into the same memory address. The duplicator 142a adds this new value “864” to the frame 57 (FIG. 19A), together with the statistical data ID “006_{—}10” mentioned above. The result is seen as a frame 58 in FIG. 20A.

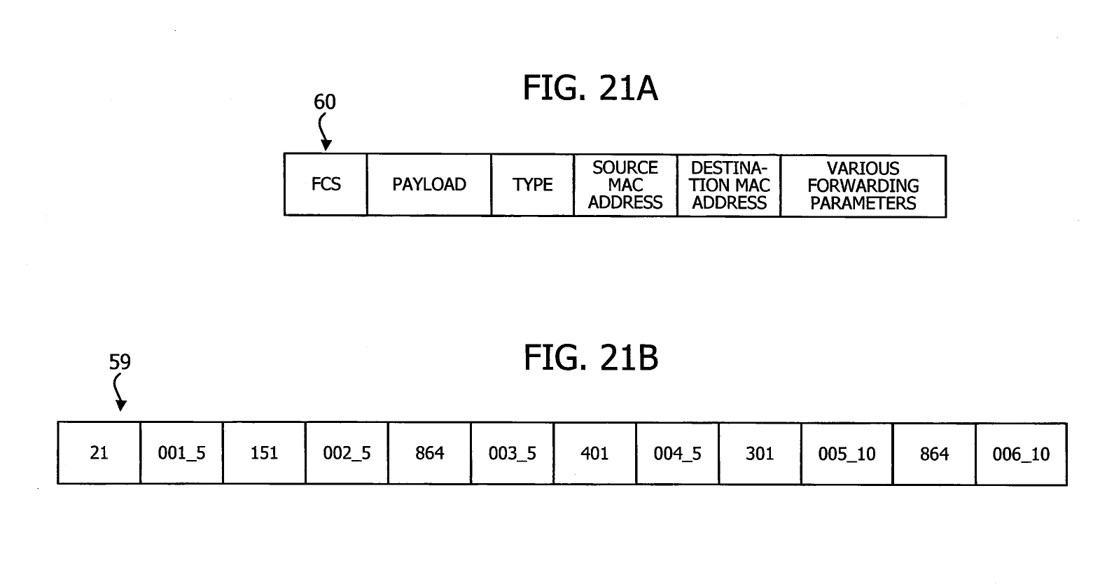

(Step S23) Based on the given frame, the duplicator 142a produces two duplicated frames, namely, a frame to be forwarded to the switch card 103 (e.g., frame 60 in FIG. 21A) and a statistics transmission data frame (e.g., frame 59 in FIG. 21B) to be transferred to the storage device 160. In this processing, the duplicator 142a may remove unnecessary portions. For example, the payload field is removed to produce the statistics transmission data frame 59.

Referring again to FIGS. 13 and 14, two frames are illustrated to explain the data structure of statistics transmission data frames according to the second embodiment. Specifically FIG. 13 illustrates an exemplary frame 51 that the interface card 102a receives from a communication link. This frame 51 is formed from the following data fields: “Destination MAC Address” (MAC DA: Media Access Control Destination Address), “Source MAC Address” (MAC SA: Media Access Control Source Address), “Type,” “Payload,” and “FCS.” The destination MAC address field contains an address that uniquely identifies a communication interface of a terminal device to which the frame 51 is directed. The source MAC address field contains an address that uniquely identifies a communication interface of a terminal device from which the frame 51 is transmitted. The type field indicates which protocol is used in the frame 51. The payload field carries substantive data to be delivered. For example, an IP packet is divided into a plurality of fixed-length segments, and the payload field carries one segment at a time. The FCS field contains a value used to detect error in the frame 51 at the receiving end.

The data structure of frames actually depends on the implementation of the network, and there may be a number of variations. Some additional parameters may be added to the frame 51 illustrated in FIG. 13. For example, the frame 52 of FIG. 14 is a modified version of the FIG. 51 of FIG. 13, in which a port ID and a flow ID are added.

FIGS. 15A and 15B illustrate an exemplary data structure of a statistics transmission data frame according to the second embodiment, and how a normal frame Rx counter changes its value. As seen in FIG. 15A, the illustrated frame 53 is derived from the above frame 52 by adding the value of a normal frame Rx counter 172a and a management ID. FIG. 15B illustrates a change in the value of the normal frame Rx counter 172a as a consequence of reception of a frame 51.

FIGS. 16A and 16B illustrate another exemplary data structure of a statistics transmission data frame according to the second embodiment, and how a unicast frame Rx counter changes its value. As seen in FIG. 16A, the illustrated frame 54 is derived from the above frame 53 by adding the value of a unicast frame Rx counter 172b and a management ID. FIG. 16B illustrates a change in the value of the unicast frame Rx counter 172b as a consequence of reception of a frame 51.

FIGS. 17A and 17B illustrate yet another exemplary data structure of a statistics transmission data frame according to the second embodiment, and how an Rx byte counter changes its value. As seen in FIG. 17A, the illustrated frame 55 is derived from the above frame 54 by adding the value of an Rx byte counter 172f and management ID. FIG. 17B illustrates a change in the value of the Rx byte counter 172f as a consequence of reception of a frame 51.

FIGS. 18A and 18B illustrate yet another exemplary data structure of a statistics transmission data frame according to the second embodiment, and how a designated-size frame Rx counter changes its value. As seen in FIG. 18A, the illustrated frame 56 is derived from the above frame 55 by adding the value of a designated-size frame Rx counter 172h and a management ID. FIG. 18B illustrates a change in the value of the designated-size frame Rx counter 172h as a consequence of reception of a frame 51.

FIGS. 19A and 19B illustrate still another exemplary data structure of a statistics transmission data frame according to the second embodiment, and how a flow-specific normal frame Rx counter changes its value. As seen in FIG. 19A, the illustrated frame 57 is derived from the above frame 56 by adding the value of a flow-specific normal frame Rx counter 175a and a management ID. FIG. 19B illustrates a change in the value of the flow-specific normal frame Rx counter 175a as a consequence of reception of a frame 51.

FIGS. 20A and 20B illustrate still another exemplary data structure of a statistics transmission data frame according to the second embodiment, and how a flow-specific Rx byte counter changes its value. As seen in FIG. 20A, the illustrated frame 58 is derived from the above frame 57 by adding the value of a flow-specific Rx byte counter 175b and a management ID. FIG. 20B illustrates a change in the value of the flow-specific Rx byte counter 175b as a consequence of reception of a frame 51.

FIGS. 21A and 21B illustrate exemplary data structures of duplicated frames according to the second embodiment. Specifically, FIG. 21A illustrates a frame 60 to be passed from the interface card 102a to the switch card 103. FIG. 21B illustrates a statistics transmission data frame 59 to be transferred from the arbiter 153 in the interface card 102a to the storage device 160.

As can be seen from the above description, the second embodiment enables the switch 100 to collect statistical data values with a less amount of software processing, a lower occupancy of CPU control bus, and a smaller memory requirement for storage of statistical data. It is also noted that the multiplexing unit 150 is designed to use LIFO memory. This eliminates the need for using dedicated components for the frame processing unit 130 and queue control unit 140, thus widening the choice of components in circuit design of the interface card 102a.

### (c) THIRD EMBODIMENT

This section describes a third embodiment. The description focuses on its difference from the foregoing second embodiment, using like reference numerals for like elements. Specifically, the third embodiment is different from the second embodiment in that LIFO memories are located in its frame processing unit and queue control unit.

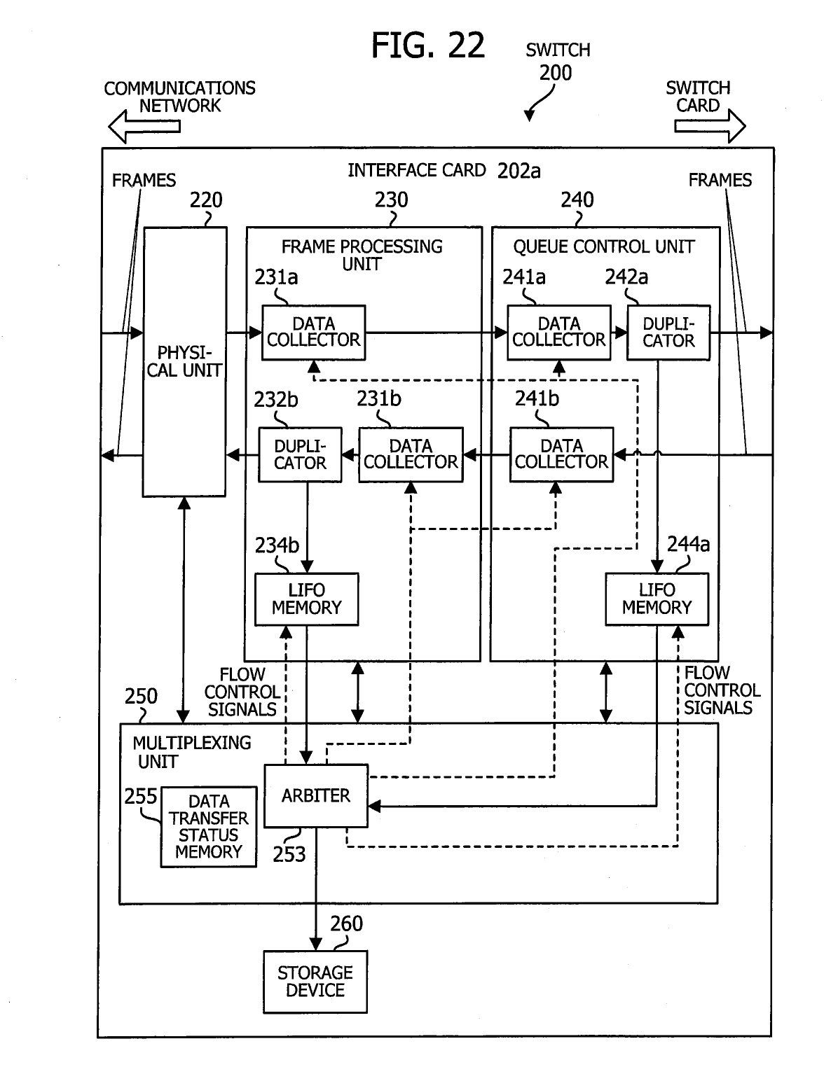

FIG. 22 is a functional block diagram of an interface card according to the third embodiment. The third embodiment uses hardware-based control functions for collecting statistical data values from each frame when it is received by an interface card 202a in the illustrated switch 200. The collected statistical data values are duplicated as a statistics transmission data frame, which is transferred to a storage device 260. Relevant statistical data values in the storage device 260 are then updated with new statistical data values in the transferred statistics transmission data frame, under the software-based control.

According to the third embodiment, the interface card 202a includes a physical unit 220, a frame processing unit 230, a queue control unit 240, a multiplexing unit 250, and a storage device 260. The frame processing unit 230 includes two data collectors 231a and 231b, a duplicator 232b, and a LIFO memory 234b. Similarly the queue control unit 240 includes data collectors 241a and 241b, a duplicator 242a, and a LIFO memory 244a. The multiplexing unit 250 includes an arbiter 253 and a data transfer status memory 255.

The switch 200 receives frames with its interface card 202a. The data collectors 231a, 231b, 241a, and 241b collect a plurality of statistical data values describing communication activities, based on the frames carrying user data. The data collectors 231a, 231b, 241a, and 241b add a management ID to each of the collected statistical data values, thus producing a statistics transmission data frame. These features enable the switch 200 to collect a plurality of statistical data values describing received frames and transmit the collected statistical data values all together to the storage device 260. The processing load on the switch 200 may therefore be reduced.

The duplicator 242a operates similarly to the duplicator 142a in the second embodiment. That is, the duplicator 242a is supplied with statistical data values that the data collectors 231a and 241a have collected on the basis of frames received by the interface card 202a from a communication link. The duplicator 242a adds a management ID to each statistical data value and compiles them into a single statistics transmission data frame.

The duplicator 232b operates similarly to the duplicator 132a in the second embodiment. That is, the duplicator 232b is supplied with statistical data values that the data collectors 231b and 241b have collected on the basis of frames supplied from the switch card. The duplicator 232b compiles those statistical data values into a single statistics transmission data frame, while adding a management ID to each statistical data value. The data collectors 231a, 231b, 241a, and 241b, duplicators 232b and 242a may collectively function as the foregoing collection unit 1a of the first embodiment.

In the multiplexing unit 250, the arbiter 253 transfers statistics transmission data frames produced by the data collectors 231a, 231b, 241a, and 241b to the storage device 260 in a similar way to the arbiter 153 in the foregoing second embodiment. Statistical data values in each statistics transmission data frame are thus written into the storage device 260 with hardware-based processing. The multiplexing unit 250 may function as the control unit 1b discussed in the first embodiment.

Upon receipt of a user data frame relevant to statistics transmission data corresponding to a specific management data tag, the arbiter 253 stores a transfer status flag in the data transfer status memory 255 to indicate that the statistics transmission data corresponding to the management data tag has not been transferred. Upon completion of transferring statistics transmission data in the LIFO memories 154a and 154b to the storage device 160, the arbiter 153 stores a transfer status flag in the data transfer status memory 155 to indicate the completion of transferring of the statistics transmission data.

The LIFO memories 234b and 244a are where statistics transmission data is written and read in a last-in first-out fashion, similarly to the LIFO memories 154a and 154b discussed in the second embodiment. The latter LIFO memory 244a is integrated in the queue control unit 240, together with the data collectors 241a and 241b and duplicator 242a. The former LIFO memory 234b is integrated in the frame processing unit 230, together with the data collectors 231a and 231b and duplicator 232b.

The arbiter 253 allows the LIFO memories 234b and 244a to store newly produced statistics transmission data frames for the time being. The arbiter 253 reads those stored statistics transmission data frames out of the LIFO memories 234b and 244a and transfers them to their destinations. This feature enables adjustment of the timing of transferring statistics transmission data frames. That is, statistics transmission data frames are produced at the same speed as the interface card 202a receives frames, and thus stored in the LIFO memories 234b and 244a at that speed. The LIFO memories 234b and 244a are used to adjust the timing of DMA transfer of statistics transmission data frames to the storage device 260.

One LIFO memory 244a stores statistics transmission data frames produced from frames received by the interface card 202a from a communications network. Another LIFO memory 234b stores statistics transmission data frames produced from frames that enter the interface card 202a from the switch card. Unlike the second embodiment, the arbiter 253 uses some external signal (flow control signals), when transferring a statistics transmission data frame to the storage device 260, to indicate which LIFO memory, 244a or 234b, will be the source of that transfer.

The data transfer status memory 255 stores transfer status flags that indicate whether the statistics transmission data corresponding to each management data tag has been transferred. Those transfer status flags permit the arbiter 253 to know the completion or incompletion of data transfer for a specific statistics transmission data frame to the storage device 260.

The storage device 260 stores each statistical data value according to its corresponding management data tag, based on statistics transmission data frames transferred from the multiplexing unit 250.

According to the third embodiment, the interface card 202a obtains various statistical data values from its input frames and stores them in the storage device 260. As in the second embodiment, those statistical data values include the following items: the number of transmitted unicast frames, the number of received unicast frames, the number of transmitted multicast frames, the number of received multicast frames, the number of transmitted broadcast frames, the number of received broadcast frames, the number of transmitted PAUSE frames (frames indicating buffer status), the number of received PAUSE frames, the number of bytes of outgoing frames, the number of bytes of received frames, the number of transmitted frames with specific lengths, the number of received frames with specific lengths, the number of transmitted normal frames, the number of received normal frames, the number of outgoing frames that are discarded, and the number of received frames that are discarded. These statistical data values may be summarized on an individual port basis, or an individual service basis, or an individual flow basis. It is noted that the statistical data values enumerated above are only an example. In actual implementations, the interface cards may be designed to collect a subset of the above items, or may be enhanced to collect more data items than the above.

As can be seen from the above description, the third embodiment places two LIFO memories 234b and 244a in the frame processing unit 230 and queue control unit 240, respectively, so that the write operation of statistics transmission data frames is executed locally in the frame processing unit 230 and queue control unit 240. This arrangement of the LIFO memories reduces the bandwidth requirement at the interface between the multiplexing unit 250 and the frame processing unit 230 and queue control unit 240.

### (d) CONCLUSION

Three embodiments and their examples have been described above. The disclosed communication apparatus collects statistical data with a reduced amount of processing load, as do the disclosed control apparatus and method for collecting statistical data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A communication apparatus comprising:
a collector that collects a plurality of statistical data values describing communication activities, based on given user data frames, and produces statistics transmission data including the collected statistical data values and management data tags added thereto;
a controller that transfers the produced statistics transmission data by using a direct memory access technique; and
a memory that stores the statistics transmission data transferred by the controller.

2. The communication apparatus according to claim 1, further comprising a temporary memory to temporarily store the statistics transmission data produced by the collector,
wherein the controller adjusts timing of the transferring of the statistics transmission data by temporarily storing the produced the statistics transmission data in the temporary memory before transferring the statistics transmission data to the memory.

3. The communication apparatus according to claim 2, wherein the statistics transmission data is written in and read out of the temporary memory in a last-in first-out fashion.

4. The communication apparatus according to claim 1, wherein:
the user data frames each include a control data field and a payload field; and
the collector produces the statistics transmission data by removing the payload field from the user data frames.

5. The communication apparatus according to claim 2, further comprising a data transfer status memory to store transfer status information indicating whether the statistics transmission data corresponding to the management data tag has been transferred,
wherein:
the controller stores, upon receipt of a user data frame relevant to the statistics transmission data corresponding to a specific management data tag, a piece of transfer status information in the data transfer status memory to indicate that the statistics transmission data corresponding to the specific management data tag has not been transferred, and
the controller stores, upon completion of transferring the statistics transmission data from the temporary memory to the memory, a piece of transfer status information in the transfer status memory to indicate the completion of transferring of the statistics transmission data.

6. The communication apparatus according to claim 1, wherein one of the plurality of statistical data values indicates a number of received data frames that contain buffer status information.

7. The communication apparatus according to claim 1, wherein one of the plurality of statistical data values indicates a number of bytes of the received user data frames.

8. The communication apparatus according to claim 1, wherein one of the plurality of statistical data values indicates a number of received user data frames that are discarded.

9. The communication apparatus according to claim 1, wherein
one of the plurality of statistical data values indicates a number of received user data frames whose lengths fall in a specified range.

10. The communication apparatus according to claim 1, wherein one of the plurality of statistical data values indicates a number of user data frames that are received properly.

11. The communication apparatus according to claim 1, wherein one of the plurality of statistical data values indicates a number of transmitted data frames that contain buffer status information.

12. The communication apparatus according to claim 1, wherein one of the plurality of statistical data values indicates a number of bytes of transmitted user data frames.

13. The communication apparatus according to claim 1, wherein one of the plurality of statistical data values indicates a number of outgoing user data frames that are discarded without transmission.

14. The communication apparatus according to claim 1, wherein one of the plurality of statistical data values indicates a number of transmitted user data frames whose lengths fall within a specified range.

15. The communication apparatus according to claim 1, wherein one of the plurality of statistical data values indicates a number of user data frames that are transmitted properly.

16. The communication apparatus according to claim 1, wherein the statistical data values are collected on an individual service basis.

17. The communication apparatus according to claim 1, wherein:
the management data tags are respectively associated with the statistical data values; and
the memory stores each statistical data value of the transferred statistics transmission data according to the management data tag associated therewith.

18. A control apparatus for collecting statistical data values, comprising:
a collector that collects a plurality of statistical data values describing communication activities, based on given user data frames, and produces statistics transmission data including the collected statistical data values and management data tags added thereto; and
a controller that transfers the produced statistics transmission data to a storage location by using a direct memory access technique;

19. A control method for collecting statistical data values, comprising:
collecting a plurality of statistical data values describing communication activities, based on given user data frames;
producing statistics transmission data including the collected statistical data values and management data tags added thereto; and
transferring the produced statistics transmission data to a storage location by using a direct memory access technique.
